(19) United States
(12) Patent Application Publication
(10) Pub. No.: US 2026/0251235 A1
(43) Pub. Date: Aug. 27, 2026

(54) HIGH-PRECISION ABOVE-GROUND AND UNDERGROUND TWO-WAY COMMUNICATION TRENCHLESS PIPELINE CONSTRUCTION AND DETECTION SYSTEM

(71) Applicant: Suzhou Kensor Instrument Technology Co., Ltd., Suzhou (CN)

(72) Inventors: Xiaopeng Wang, Suzhou (CN); Jinhua Huang, Suzhou (CN); Jing Cao, Suzhou (CN)

(21) Appl. No.: 19/456,311

(22) Filed: Jan. 22, 2026

(30) Foreign Application Priority Data
Feb. 21, 2025 (CN) 202510195392.X

(51) Int. Cl. F16L 1/11; F16L 1/028

(52) U.S. Cl. CPC F16L 1/11; F16L 1/028

(57) ABSTRACT

A high-precision above-ground and underground two-way communication trenchless pipeline construction and detection system, comprising a transmitter A, a receiver A, a transmitter B and a receiver B. The transmitter A and receiver B are located underground and arranged at a construction drill pipe at a front end of a drilling rig pipeline; the receiver A and transmitter B are located on the ground and arranged at the position of the guidance operator; the transmitter A and receiver A operate in the same frequency band, with transmitter A configured to transmit electromagnetic waves modulated with digital information. The entire process adopts two-way communication: a set of transmitting and receiving system is arranged on the ground, and another set is arranged underground, forming a closed loop for digital information transmission, which can eliminate impact of interference sources around the ground receiver, and impact of metal interferences during magnetic field propagation.

### TECHNICAL FIELD

The invention relates to the technical field of pipeline detection, in particular to a high-precision above-ground and underground two-way communication trenchless pipeline construction and detection system.

### BACKGROUND ART

At present, during trenchless pipeline construction, wireless guidance instruments are generally used for real-time positioning and depth calculation of construction drill bits; such guidance instruments can also be applied to detect the direction and depth of already laid pipelines. The realization principle of these functions of the guidance instrument is based on the magnetic field propagation path law and signal amplitude attenuation law of magnetic dipoles: a magnetic field emission source is placed inside the pipeline, a 3D orthogonal antenna is used on the ground to receive magnetic field signals, and the azimuth and depth of the current drill bit are obtained after calculation and processing by a DSP chip. The current wireless guidance instruments have three major problems: the limited installation space of the underground emission source restricts the increase of its transmission power, which affects the signal propagation distance; the currently used signal frequency band is around 0.3-40 kHz. During propagation, magnetic field signals in this frequency band are susceptible to interference from various metal objects, which alters the propagation law and signal attenuation law and thus causes deviations in positioning and depth calculation; interference signals emitted by various electrical equipment on the ground also greatly affect the accuracy of the receiving instrument.

As shown in FIG. 1, during trenchless construction, a drilling rig provides power to push or pull drill pipes or pipelines through the pre-planned underground path. During construction, it is essential to obtain the real-time and accurate depth, azimuth and attitude of the current drill bit to guide subsequent construction operations. The currently adopted solution is to place a transmitting probe at the foremost end of the drill pipe for construction pipelines. The probe is mainly composed of a battery, sensors and a magnetic field signal transmitting antenna. The sensors detect the dip angle and face angle of the current probe; the transmitting antenna emits magnetic field signals modulated with digital information, which includes the dip angle and face angle of the probe detected by the sensors. The probe is powered by the battery. On the ground, a guide operator holds a receiver, which receives the magnetic field signals through a 3D orthogonal antenna. The azimuth of the underground transmitting probe can be determined according to the signal amplitude and the positive-negative relationship of the signals received by the three antennas. The dip angle, face angle and other information of the underground probe can be obtained by parsing the digital information carried by the magnetic field signals. Among this information, the dip angle and face angle of the probe are transmitted via digital modulation and demodulation. Owing to the strict error detection mechanism, the parsed data are guaranteed to be accurate once successfully decoded by the receiver. However, the azimuth and depth of the probe are calculated based on the amplitude of the magnetic field signals. Affected by propagation path interference (frequency band: 0.3–40 k ) and ground interference, the accuracy of the magnetic field amplitude is significantly impaired and even incorrect data may be generated, which will seriously affect construction progress and even lead to severe construction accidents. Therefore, the invention proposes a high-precision above-ground and underground two-way communication trenchless pipeline construction and detection system to solve the problems existing in the prior art.

### SUMMARY OF THE INVENTION

Aiming at the above-mentioned problems, the invention proposes a high-precision above-ground and underground two-way communication trenchless pipeline construction and detection system. The entire operation process of this system adopts two-way communication: a set of transmitting and receiving system is configured on the ground, and another set is deployed underground, forming a closed loop for digital information transmission. This design can eliminate the impact of interference sources around the ground receiver and metal interferences during magnetic field propagation, thereby achieving accurate trenchless pipeline construction and detection.

To achieve the purpose of the invention, the invention is realized by the following technical solutions: a high-precision above-ground and underground two-way communication trenchless pipeline construction and detection system, comprising a transmitter A, a receiver A, a transmitter B and a receiver B. The transmitter A and receiver B are located underground and arranged at a construction drill pipe at a front end of a drilling rig pipeline; the receiver A and transmitter B are located on the ground and arranged at the position of the guidance operator; the transmitter A and receiver A operate in the same frequency band, with transmitter A configured to transmit electromagnetic waves modulated with digital information, and receiver A configured to receive the electromagnetic waves, demodulate the digital information, and calculate the depth relationship and azimuth relationship with transmitter A; transmitter B and receiver B operate in the same frequency band, with transmitter B configured to transmit electromagnetic waves modulated with digital information, and receiver B configured to receive the electromagnetic waves, demodulate the digital information, and calculate the depth relationship and azimuth relationship with transmitter B;

the receiver B sends the parsed information about the depth and azimuth relationship with transmitter B to transmitter A; meanwhile, the transmitter A digitally transmits its parsed own face angle and dip angle, as well as the received depth and azimuth information sent by receiver B, to receiver A, so as to realize the digital processing of depth and azimuth information.

A further improvement is that: the transmitter A and receiver A operate in a frequency band of 0.3–40 k, and the transmitter B and receiver B operate in a frequency band of 1–100 Hz.

A further improvement is that: the transmitter B is designed for mobile operation at any time, and consists of a power battery, an inverter and a transmitting antenna; the output frequency of the inverter is 1–100 Hz, the DC bus voltage is 100–200 V, and the transmitting antenna is composed of a copper coil wound on a magnetic core.

A further improvement is that: the transmitter A has the same structure as transmitter B, and the transmission voltage of transmitter A is 10–20 V.

A further improvement is that: the receiver A is used for receiving magnetic field signals of 0.3–40 k to perform positioning and data parsing of transmitter A, and the receiver A consists of a receiving coil, a DSP (digital signal processor) and a display screen; the receiver B is used for receiving magnetic field signals of 1–100 Hz to perform positioning and data parsing of transmitter B, and the receiver B consists of a receiving coil and a DSP.

A further improvement is that: the receiving coil of the receiver A is an orthogonal combination of multiple groups of air-core coils; the receiving coil of the receiver B is one selected from an orthogonal combination of multiple groups of air-core coils, an induction coil and a fluxgate sensor; the DSP is a digital signal processing chip, which is used for sending the parsed data to the display screen for display.

A further improvement is that: the receiver B sends the information parsed by itself to transmitter A for unified transmission by transmitter A, and the connection and transmission mode between receiver B and transmitter A is a wired or short-range wireless transmission mode.

A further improvement is that: when the working condition is simple and the ground interference is low, the working mode of cooperation between transmitter A and receiver A is adopted; when the working condition is complex and the accuracy requirement is high, the working mode of mutual cooperation between transmitter A, receiver A, transmitter B and receiver B is adopted.

Beneficial effects of the invention are as follows:
1. The invention adopts the mutual cooperation of transmitter A, receiver A, transmitter B and receiver B. transmitter A and transmitter B respectively transmit electromagnetic waves modulated with digital information to receiver A and receiver B. After receiving the electromagnetic waves, receiver A and receiver B demodulate the digital information and calculate the depth relationship and azimuth relationship with the transmitting location; receiver B sends the parsed information about the depth and azimuth relationship with transmitter B to transmitter A. Meanwhile, transmitter A digitally transmits its parsed own face angle and dip angle, as well as the received depth and azimuth information sent by receiver B, to receiver A for display. The entire process adopts two-way communication: a set of transmitting and receiving system is arranged on the ground, and another set is arranged underground, forming a closed loop for digital information transmission. This design can eliminate the impact of interference sources around the ground receiver, as well as the impact of metal interferences during magnetic field propagation, thereby achieving accurate trenchless pipeline construction and detection.
2. The transmitter A and receiver A of the invention operate in a frequency band of 0.3–40 k, while transmitter B and receiver B operate in a frequency band of 1–100 Hz. The ultra-low frequency signals transmitted on the ground can achieve infinitely high power; such ultra-low frequency signals feature excellent penetration, can be parsed underground with minimal interference, and realize high-accuracy results through digital transmission when the information including depth and azimuth is transmitted back to the ground, thus achieving ultra-strong anti-interference performance for depth and azimuth detection.

### BRIEF DESCRIPTION OF ACCOMPANY DRAWINGS

FIG. 1 is a schematic diagram of the prior art;

FIG. 2 is a schematic principle diagram of the invention;

FIG. 3 is a block diagram showing the composition of transmitter B of the invention;

FIG. 4 is a block diagram showing the composition of receiver A of the invention;

FIG. 5 is a communication schematic diagram of transmitter A and receiver B of the invention.

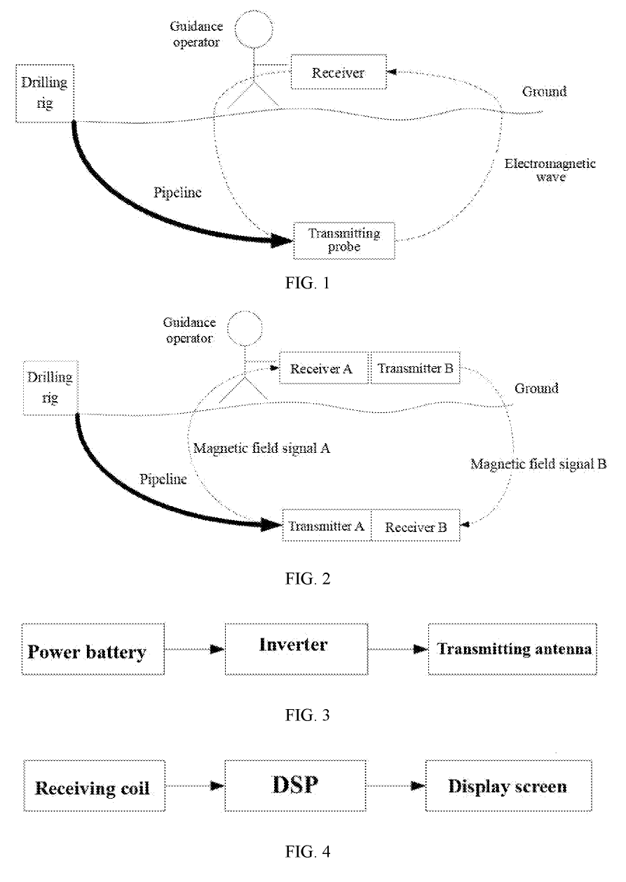

### SPECIFIC EMBODIMENT OF THE INVENTION

To further deepen the understanding of the invention, the invention will be described in detail below in conjunction with the Embodiments. These Embodiments are only used to explain the invention and do not constitute a limitation on the protection scope of the invention.

### Embodiment 1

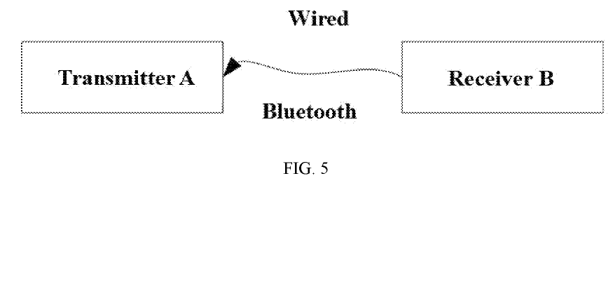

According to FIG. 2, FIG. 3, FIG. 4, and FIG. 5, the Embodiment proposes a high-precision above-ground and underground two-way communication trenchless pipeline construction and detection system, comprising a transmitter A, a receiver A, a transmitter B and a receiver B. The transmitter A and receiver B are located underground and arranged at the construction drill pipe at a front end of a drilling rig pipeline; the receiver A and transmitter B are located on the ground and arranged at the position of the guidance operator. The transmitter A and receiver A operate in the same frequency band, with transmitter A configured to transmit electromagnetic waves modulated with digital information, and receiver A configured to receive the electromagnetic waves, demodulate the digital information, and calculate the depth relationship and azimuth relationship with transmitter A; transmitter B and receiver B operate in the same frequency band, with transmitter B configured to transmit electromagnetic waves modulated with digital information, and receiver B configured to receive the electromagnetic waves, demodulate the digital information, and calculate the depth relationship and azimuth relationship with transmitter B. The transmitters emit electromagnetic waves modulated with digital information; the receivers receive the electromagnetic waves, demodulate the digital information, and calculate the depth relationship and azimuth relationship with the transmitters according to the amplitude of the received electromagnetic waves;

the receiver B sends the parsed information about the depth and azimuth relationship with transmitter B to transmitter A. Meanwhile, transmitter A digitally transmits its parsed own face angle and dip angle, as well as the received depth and azimuth information sent by receiver B, to receiver A for display on the display screen, thus realizing the digital processing of depth and azimuth information.

The transmitter A and receiver A operate in a frequency band of 0.3–40 k. This frequency band has both a certain transmission energy and a certain penetration capability, enabling information transmission at a certain rate; the transmitter B and receiver B operate in a frequency band of 1–100 Hz; signals in this frequency band have strong penetration capability and can resist interference from metal objects, but the signal energy of this frequency band is very low. Therefore, transmitter B on the ground needs to have a large transmission power to meet the positioning requirements within a depth of 30 meters. The environment around the underground receiver B is generally relatively clean, with the maximum interference being 50 Hz interference from power lines, which can be removed through designated filtering. However, various types of interference exist on the ground, especially strong pulse interference, which will have a very significant impact. Electromagnetic waves are divided into high frequency, medium frequency, low frequency, ultra-low frequency, etc.; ultra-low frequency generally refers to the level of several kilohertz or several hertz. Although signals in this frequency band carry small energy during propagation, they have excellent penetration capability. For through-the-earth communication or deep-sea communication, signals in this frequency band are generally selected; such signals are mostly used in the military field or oil exploitation field, and later are also widely used in the field of trenchless construction and pipeline detection, because trenchless construction and detection are generally carried out at an underground depth of several meters to tens of meters.

The transmitter B is used for mobile operation at any time and needs to provide high transmission power, the transmitter B is composed of a power battery, an inverter and a transmitting antenna. The power battery is generally a power lithium battery, which can meet the 12-hour operation requirement, for example, with a capacity of 1–5 kWh and a voltage of generally 24 V or 48 V. The output frequency of the inverter is 1–100 Hz, and the DC bus voltage is 100–200 V. The transmitting antenna is composed of a copper coil wound on a magnetic core, with an inductance of several hundred millihenries.

The transmitter A has the same structure as transmitter B, and the transmission voltage of transmitter A is 10–20 V. The capacity of the power battery of transmitter A is smaller than that of transmitter B, generally consisting of two 18650 battery cells, and the transmitting antenna of transmitter A is also smaller.

The receiver A is used for receiving magnetic field signals of 0.3–40 k for positioning and data parsing of transmitter A, and the receiver A is composed of a receiving coil, a DSP (digital signal processor) and a display screen; the receiver B is used for receiving magnetic field signals of 1–100 Hz for positioning and data parsing of transmitter B, and receiver B is composed of a receiving coil and a DSP.

The receiving coil adopts an air-core coil, which is composed of 3 groups combined in a 3D orthogonal structure, with an inductance value of generally several millihenries. The DSP selects an advanced dedicated digital signal processing chip and sends the parsed data to the display screen for display. Compared with receiver A, receiver B has a smaller receiving coil and does not have a display screen because it needs to be placed inside the drill pipe head.

The receiver B sends the information parsed by itself to transmitter A for unified transmission by transmitter A. The connection and transmission mode between receiver B and transmitter A is wired or short-range wireless transmission. receiver B sends the information parsed by itself to transmitter A for transmission by transmitter A, and the distance between them is very short, ranging from 0.5 m to 1 m. As shown in FIG. 5, the communication mode adopts wired transmission or short-range wireless transmission such as Bluetooth and 433 MHz.

When the working condition is simple and the ground interference is small, the working mode of cooperation between transmitter A and receiver A is adopted; when the working condition is complex and the accuracy requirement is high, the working mode of mutual cooperation between transmitter A, receiver A, transmitter B and receiver B is adopted. The two sets of working modes can be used independently or together according to the application scenarios, which are suitable for various working conditions and have high cost performance.

### Embodiment 2

According to FIG. 2, FIG. 3, FIG. 4, and FIG. 5, the Embodiment proposes a high-precision above-ground and underground two-way communication trenchless pipeline construction and detection system, comprising transmitter A, receiver A, transmitter B and receiver B. The transmitter A and receiver B are located underground and arranged at the construction drill pipe at a front end of the drilling rig pipeline; the receiver A and transmitter B are located on the ground and arranged at the position of the guidance operator; the transmitter A and receiver A operate in the same frequency band, with transmitter A configured to transmit electromagnetic waves modulated with digital information, and receiver A configured to receive the electromagnetic waves, demodulate the digital information, and calculate the depth relationship and azimuth relationship with transmitter A. The transmitter B and receiver B operate in the same frequency band, with transmitter B configured to transmit electromagnetic waves modulated with digital information, and receiver B configured to receive the electromagnetic waves, demodulate the digital information, and calculate the depth relationship and azimuth relationship with transmitter B. The transmitters emit electromagnetic waves modulated with digital information; the receivers receive the electromagnetic waves, demodulate the digital information, and calculate the depth relationship and azimuth relationship with the transmitters according to the amplitude of the received electromagnetic waves.

The receiver B sends the parsed information about the depth and azimuth relationship with transmitter B to transmitter A. Meanwhile, transmitter A digitally transmits its parsed own face angle and dip angle, as well as the received depth and azimuth information sent by receiver B, to receiver A for display on the display screen, thus realizing the digital processing of depth and azimuth information.

The transmitter A and receiver B can also be integrated as a whole; in this case, the receiver B uses an induction coil or a fluxgate sensor as the receiving coil.

When wireless transmission is subject to interference, the way of transmitting underground signals to the ground can be replaced by the way of transmitting underground transmitter A to the drilling rig end through wired transmission.

The position can be determined by parsing the ground azimuth angle underground, or by the method of the maximum value of the underground signal. When the signal value parsed underground is the maximum, it means that the above-ground transmitter (transmitter B) is closest to the underground receiver (receiver B), that is, it is directly above the underground transmitter (transmitter A).

The high-precision above-ground and underground two-way communication trenchless pipeline construction and detection system adopts the mutual cooperation of transmitter A, receiver A, transmitter B and receiver B. The transmitter A and transmitter B respectively transmit electromagnetic waves modulated with digital information to receiver A and receiver B. After receiving the electromagnetic waves, receiver A and receiver B demodulate the digital information and calculate the depth relationship and azimuth relationship with the transmitting location; receiver B sends the parsed information about the depth and azimuth relationship with transmitter B to transmitter A. Meanwhile, transmitter A digitally transmits its parsed own face angle and dip angle, as well as the received depth and azimuth information sent by receiver B, to receiver A for display, realizing the digital processing of depth and azimuth information. The entire process adopts two-way communication: a set of transmitting and receiving system is arranged on the ground, and another set is arranged underground, forming a closed loop for digital information transmission. This design can eliminate the impact of interference sources around the ground receiver, as well as the impact of metal interferences during magnetic field propagation, thereby achieving accurate trenchless pipeline construction and detection. In the invention, transmitter A and receiver A operate in a frequency band of 0.3–40 k, while transmitter B and receiver B operate in a frequency band of 1–100 Hz. The ultra-low frequency signals transmitted on the ground can achieve infinitely high power; such ultra-low frequency signals feature excellent penetration, can be parsed underground with minimal interference, and realize high-accuracy results through digital transmission when the information including depth and azimuth is transmitted back to the ground, thus achieving ultra-strong anti-interference performance for depth and azimuth detection.

The basic principles, main features and advantages of the invention have been shown and described above. It should be understood by those skilled in the art that the invention is not limited by the above Embodiments. The above Embodiments and descriptions only illustrate the principles of the invention. Without departing from the spirit and scope of the invention, the invention will have various changes and improvements, and these changes and improvements all fall within the scope of the claimed invention. The protection scope of the invention is defined by the appended claims and their equivalents.

1. A high-precision above-ground and underground two-way communication trenchless pipeline construction and detection system, comprising a transmitter A, a receiver A, a transmitter B and a receiver B; the transmitter A and receiver B are located underground and arranged at a construction drill pipe at a front end of a drilling rig pipeline; the receiver A and transmitter B are located on the ground and arranged at the position of the guidance operator; the transmitter A and receiver A operate in the same frequency band, with transmitter A configured to transmit electromagnetic waves modulated with digital information, and receiver A configured to receive the electromagnetic waves, demodulate the digital information, and calculate the depth relationship and azimuth relationship with transmitter A; transmitter B and receiver B operate in the same frequency band, with transmitter B configured to transmit electromagnetic waves modulated with digital information, and receiver B configured to receive the electromagnetic waves, demodulate the digital information, and calculate the depth relationship and azimuth relationship with transmitter B;
the receiver B sends the parsed information about the depth and azimuth relationship with transmitter B to transmitter A; meanwhile, the transmitter A digitally transmits its parsed own face angle and dip angle, as well as the received depth and azimuth information sent by receiver B, to receiver A, so as to realize the digital processing of depth and azimuth information.

2. The high-precision above-ground and underground two-way communication trenchless pipeline construction and detection system according to claim 1, wherein the transmitter A and receiver A operate in a frequency band of 0.3–40 k, and the transmitter B and receiver B operate in a frequency band of 1–100 Hz.

3. The high-precision above-ground and underground two-way communication trenchless pipeline construction and detection system according to claim 1, wherein the transmitter B is designed for mobile operation at any time, and consists of a power battery, an inverter and a transmitting antenna; the output frequency of the inverter is 1–100 Hz, the DC bus voltage is 100–200 V, and the transmitting antenna is composed of a copper coil wound on a magnetic core.

4. The high-precision above-ground and underground two-way communication trenchless pipeline construction and detection system according to claim 3, wherein the transmitter A has the same structure as transmitter B, and the transmission voltage of transmitter A is 10–20 V.

5. The high-precision above-ground and underground two-way communication trenchless pipeline construction and detection system according to claim 1, wherein the receiver A is used for receiving magnetic field signals of 0.3–40 k to perform positioning and data parsing of transmitter A, and the receiver A consists of a receiving coil, a DSP (digital signal processor) and a display screen; the receiver B is used for receiving magnetic field signals of 1–100 Hz to perform positioning and data parsing of transmitter B, and the receiver B consists of a receiving coil and a DSP.

6. The high-precision above-ground and underground two-way communication trenchless pipeline construction and detection system according to claim 5, wherein the receiving coil of the receiver A is an orthogonal combination of multiple groups of air-core coils; the receiving coil of the receiver B is one selected from an orthogonal combination of multiple groups of air-core coils, an induction coil and a fluxgate sensor; the DSP is a digital signal processing chip, which is used for sending the parsed data to the display screen for display.

7. The high-precision above-ground and underground two-way communication trenchless pipeline construction and detection system according to claim 1, wherein the receiver B sends the information parsed by itself to transmitter A for unified transmission by transmitter A, and the connection and transmission mode between receiver B and transmitter A is a wired or short-range wireless transmission mode.

8. The high-precision above-ground and underground two-way communication trenchless pipeline construction and detection system according to claim 1, wherein when the working condition is simple and the ground interference is low, the working mode of cooperation between transmitter A and receiver A is adopted; when the working condition is complex and the accuracy requirement is high, the working mode of mutual cooperation between transmitter A, receiver A, transmitter B and receiver B is adopted.
